(19) United States
(12) Patent Application Publication
(10) Pub. No.: US 2007/0266663 A1
(43) Pub. Date: Nov. 22, 2007

(54) Door and window sill gasket

(76) Inventor: John R. Hopkins, Bow Mar, CO (US)

Correspondence Address: MARSH, FISCHMANN & BREYFOGLE LLP, 3151 SOUTH VAUGHN WAY, SUITE 411, AURORA, CO, 80014, US

(21) Appl. No.: 11/652,380

(22) Filed: Jan. 11, 2007

Related U.S. Application Data
(63) Continuation of application No. 11/426,241, filed on Jun. 23, 2006.
Application No. 11/426,241 is a continuation-in-part of application No. 10/833,722, filed on Apr. 28, 2004.

(51) Int. Cl. E06B 7/205

(52) U.S. Cl. 52/411

(57) ABSTRACT

A sill gasket is adapted to seal the frame of a structure against moisture and/or air. The gasket includes a water resistant compressible material having an upper surface, a lower surface, a front edge and a rear edge provided with an upstanding backdam. The upper surface is downwardly sloped from the backdam toward the front edge. A flexible wicking material has one portion fixed to the upper surface of the compressible material, and another portion extending beyond the front edge and provided with an adhesively-coated lower face covered by a removable release liner.

### CROSS-REFERENCE TO RELATED APPLICATIONS

This application is a continuation of U.S. patent application Ser. No. 11/426,241 filed Jun. 23, 2006, which is a continuation-in-part of U.S. patent application Ser. No. 10/833,722 filed Apr. 28, 2004.

### FIELD OF THE INVENTION

The present invention generally relates to building products and, more particularly, pertains to a sealing gasket for doors and windows.

### BACKGROUND OF THE INVENTION

One of the most common failure points for unwanted air and/or moisture in a building envelope is around doors and windows. Controlling air and/or moisture is a serious concern, which may result in exterior and interior damage if not prevented or corrected in a timely manner. Recent studies have shown that the extent of such damage has run into millions of dollars annually, much of which is due to construction litigation. In addition, heat losses caused by air leakage around building openings have taken on new significance due to today's high energy costs. Sealing to date has been imperfectly accomplished by caulking and using putty-like compound around openings between door and window frames to seal the gaps and prevent inward seepage of air and/or water into the building. There is often a further problem with bugs entering through the same gaps.

In the case of a door, the caulking is typically placed between a threshold and the subfloor, but this does not stop moisture getting into the subfloor face. After a period of time, moisture from melting snow or driving rain leads not only to swelling, rotting and warpage of the subfloor and structural framing, but also racks the door frame out of square and ruins the finish flooring above the subfloor. Once this happens, the door will need constant adjustments and, more than likely, the finish flooring will need to be replaced. The moisture and humidity along with the drying and shrinking of lumber also crack the caulk so that air, water, mold and insects may infiltrate under the threshold into the building.

In window installations, caulking around the window has been the known installation and application method. However, this has proven to be a failed system because over long term, the caulking cannot withstand the constant expansion and contraction of the window itself or the substrate. Test studies show that after several years in operation, almost 100 percent of all windows either leaked through the window flange or the window itself. This water leakage along with water intrusion caused by precipitation leads to structural damage such as rotting of the window sills and mold.

Given these problems, there remains a need for an improved sealing gasket for ensuring a weather-tight barrier for door and window installations.

### SUMMARY OF THE INVENTION

It is a general object of the present invention to provide a door and window sealing gasket which overcomes the deficiencies of the prior art.

It is also an object of the present invention to provide a door and window sealing gasket which is 100 percent waterproof, and is mold and mildew resistant.

It is another object of the present invention to provide a door and window sealing gasket which stops unwanted air and/or, moisture and bug infiltration and protects sills from rotting.

It is an additional object of the present invention to provide a sealing gasket which helps prevent subfloors from swelling and structural framing from warping.

It is a further object of the present invention to provide a sealing gasket which helps stop moisture intrusion to the subfloor causing eventual destruction to the finish flooring.

Still another object of the present invention is to provide a sealing gasket which is energy efficient to reduce monthly utility costs.

Yet a further object of the present invention is to provide a door and window sealing gasket which is self-adhering to a variety of surfaces such as concrete, wood and metal.

One other object of the present invention is to provide a door and window sealing gasket which features an easy peel and stick application that offers a savings in labor costs.

An extra object of the present invention is to provide a door and window sealing gasket employing a rubberized, waterproof, modified asphalt with a high degree of elongation.

It is another object of the present invention to provide a method of supplying a sill gasket between a threshold and a subfloor.

It is also an object of the present invention to provide a method of supplying a sill gasket between a window frame and a window framework defining a window opening.

It is ye1 another object of the present invention to provide a door and window sealing gasket which utilizes commercially available materials for the manufacture thereof.

Still a further object of the present invention is to provide a sealing gasket provided with a wicking material for directing any water, moisture or condensation outside a window or door.

In one aspect of the invention, a sill gasket is adapted to seal the frame of a structure against moisture and/or air. The gasket includes a water resistant compressible material having an upper surface, a lower surface, a front edge and a rear edge provided with an upstanding backdam. The upper surface is downwardly sloped from the backdam toward the front edge. A flexible wicking material has one portion fixed to the upper surface of the compressible material, and another portion extending beyond the front edge and is provided with an adhesively-coated lower face covered by a removable release liner.

The compressible material is preferably comprised of closed cell polyethylene foam. Another portion of the wicking material is foldable downwardly over the front edge of the compressible material. The one portion of the wicking material extends beyond the backdam and the front edge on the upper surface of the compressible material.

The invention further contemplates a method of providing a sill gasket to create a positive flow of water leaked into a window away therefrom and to prevent moisture and air infiltration between a window frame and a framework having a top member, a bottom member and a pair of spaced-apart side members, each of the top, bottom and side members having a front surface defining a window opening. The method includes the steps of providing a water resistant compressible material having an upper surface, a lower surface, a front edge and a rear edge provided with an upstanding backdam, the upper surface being downwardly sloped from the backdam to the front edge, and a flexible wicking material having one portion fixed to the upper surface of the compressible material, and another portion extending beyond the front edge and provided with an adhesively-coated lower face covered by a removable release liner; securing the lower surface of the compressible material horizontally across an entire length of the bottom member of the window framework such that the another portion of the wicking material extends beyond the front surface of the bottom member; removing the release liner from the another portion of the wicking material to expose the adhesively-coated lower face thereof; folding and adhesively attaching the lower face of the another portion of the wicking material to the front surface of the bottom member; setting the window frame in the window opening on top of and in engagement with the wicking material, and fastening the window frame to the respective front surfaces of the top, bottom and side members of the framework; and applying a sealing tape over peripheral edges of the window frame along the top and side members of the framework.

Various other objects, features and advantages of the invention will be made apparent from the following description taken together with the drawings.

### BRIEF DESCRIPTION OF THE DRAWINGS

The drawings illustrate the best mode presently contemplated of carrying out the invention.

In the drawings:

FIG. 1 is a perspective view of a sill gasket embodying the present invention;

FIG. 2 is a sectional view taken on line 2-2 of FIG. 1;

FIG. 3 is a fragmentary, perspective view of a partial installation of the sill gasket in FIG. 1 on a door sill;

FIG. 4 is a view like FIG. 3 showing a finished installation of the sill gasket;

FIG. 5 is a view like FIG. 4 showing the installation of a threshold over the sill gasket;

FIG. 6 is a perspective view of an alternative embodiment of the sill gasket used in window installations;

FIG. 7 is a sectional view taken on line 7-7 of FIG. 6;

FIG. 8 is a fragmentary, perspective view of a partial installation of the sill gasket of FIG. 6 on a window sill;

FIG. 9 is a view like FIG. 8 showing a finished installation of the sill gasket;

FIG. 10 is a front view of a finished installation of the sill gasket with the window installed;

FIG. 11 is a partial sectional view of FIG. 10;

FIG. 12 is an enlarged detail view of the drain material used in the gasket of FIG. 6;

FIG. 13 is a sectional view taken on line 13-13 of FIG. 12;

FIG. 14 is a view like FIG. 6 of another alternative embodiment of the sill gasket;

FIG. 15 is a sectional view taken on line 15-15 of FIG. 14; and

FIG. 16 is a view like FIG. 10 using the sill gasket of FIG. 14.

### DETAILED DESCRIPTION OF THE INVENTION

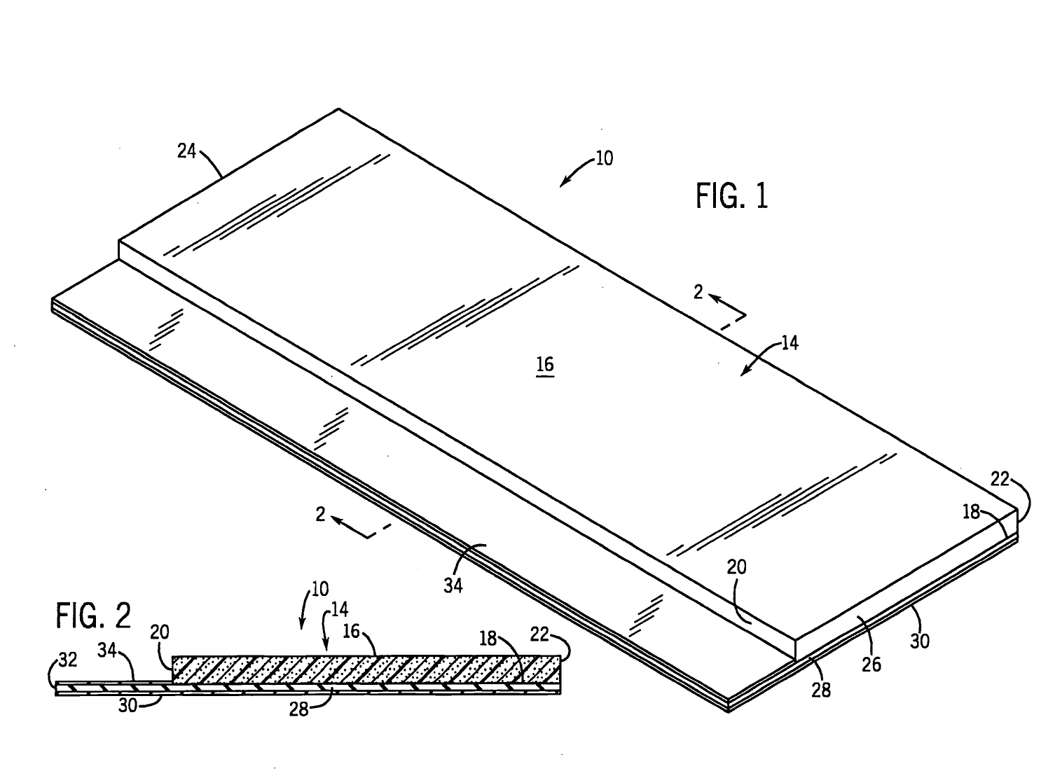

Referring now the drawings, FIGS. 1-5 illustrate a sill gasket 10 for sealing a door frame 12 against moisture, air and insect infiltration.

As seen in FIGS. 1 and 2, the sill gasket 10 includes a layer of a water resistant, compressible material 14 preferably constructed of closed cell polyethylene foam or similar material such as rubber or the like, having an upper surface 16, a lower surface 18, a front edge 20, a rear edge 22 and a pair of opposed side edges 24, 26. The lower surface 18 of the material 14 is attached to an adhesively-coated top face of a peel and stick rubberized, waterproof, modified asphalt sealing membrane 28 for providing an air/water/insect infiltration barrier. The membrane 28 has an adhesively-coated lower face covered by a peel away release liner 30, typically made of paper. The membrane 28 includes a flexible, covered gasket flange 32 which extends outwardly from the front edge 20 of the material 14. Preferably, a silicon release liner 34 is removably attached to an adhesively-coated top face of the gasket flange 32. The rubberized, waterproof, modified asphalt membrane 28 preferably has a thickness of about 40 mil. Most notably, the membrane 28 is highly elastic with an elongation of up to 500 percent. The membrane 28 is commercially available from the Protecto Wrap Company of Denver, Colo.

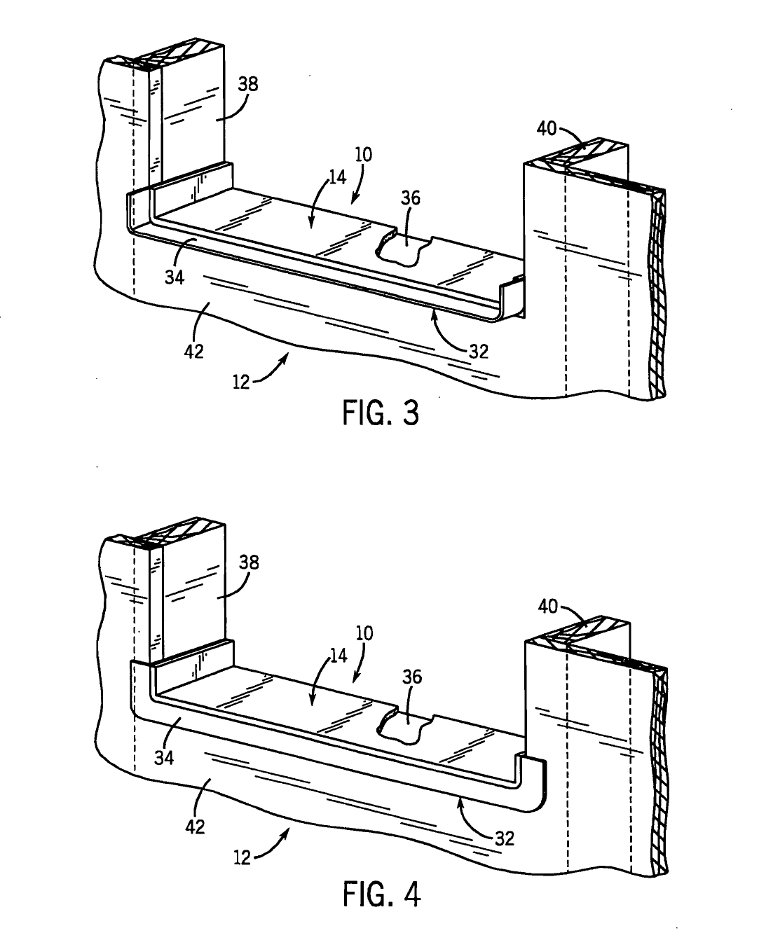

Referring now to FIGS. 3, 4 and 5, the door frame 12 includes a horizontally extending, subfloor 36 extending transversely across the bottom of a pair of spaced apart, vertically extending, door jam or framing members 38, 40. A sheathing material 42, such as OSB or plywood, is applied across the front of the door frame 12.

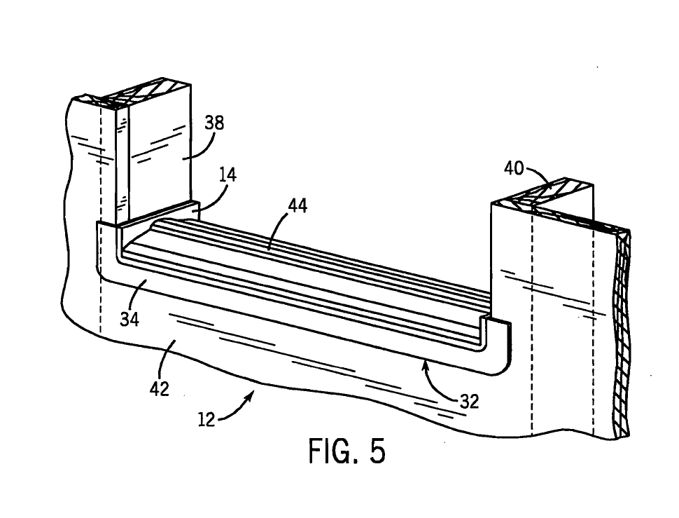

In order to place the sill gasket 10 in the bottom of the door frame 12, an installer removes the paper release liner 30 from the lower face of the membrane 28 and adhesively secures the membrane 28 with the foam 14 attached and facing upward horizontally across an entire length of the door sill 36 such that opposed ends of the membrane 28 extend vertically along and are attached to short lengths of the inside surfaces of the door jams 38,40 with the flange 32 of the membrane 28 extending forwardly from the subfloor 36 as shown in FIG. 3. Next, the installer folds the flange 32 downwardly and adhesively applies the flange 32 to respective front surfaces of the subfloor 36 and door jams 38, 40 or the sheathing 42 attached thereto as shown in FIG. 4. Once this is done, a conventional threshold 44 is fastened, such as by mechanical fasteners or the like, at least to the upper surface 16 of the foam 14 and preferably also to the subfloor 36 itself as shown in FIG. 5.

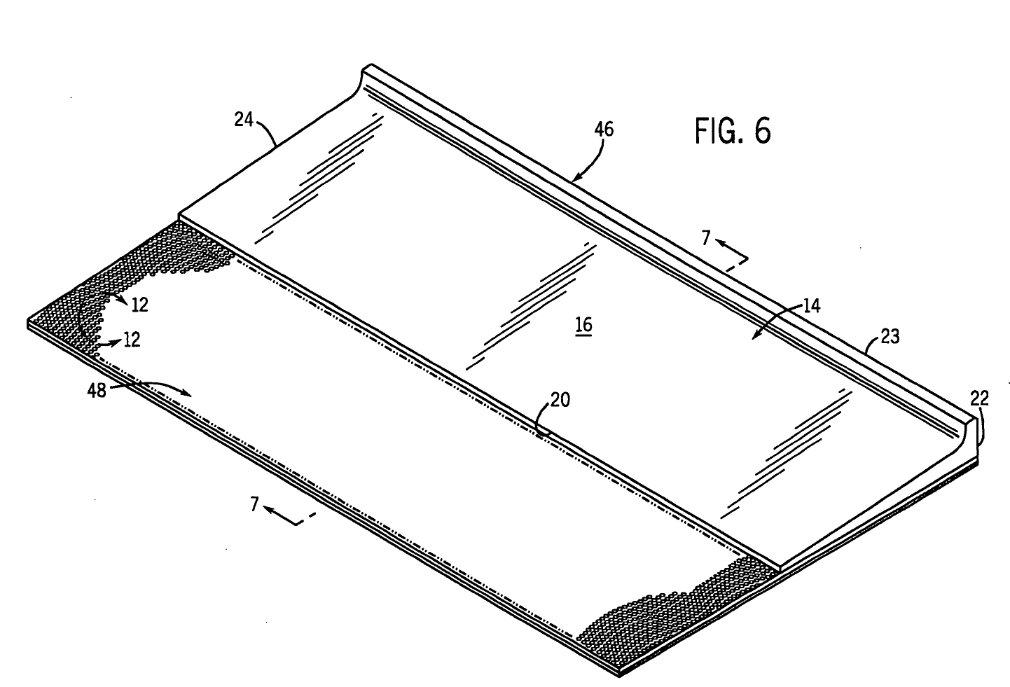

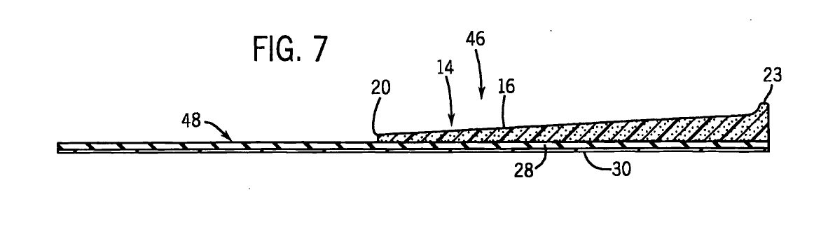

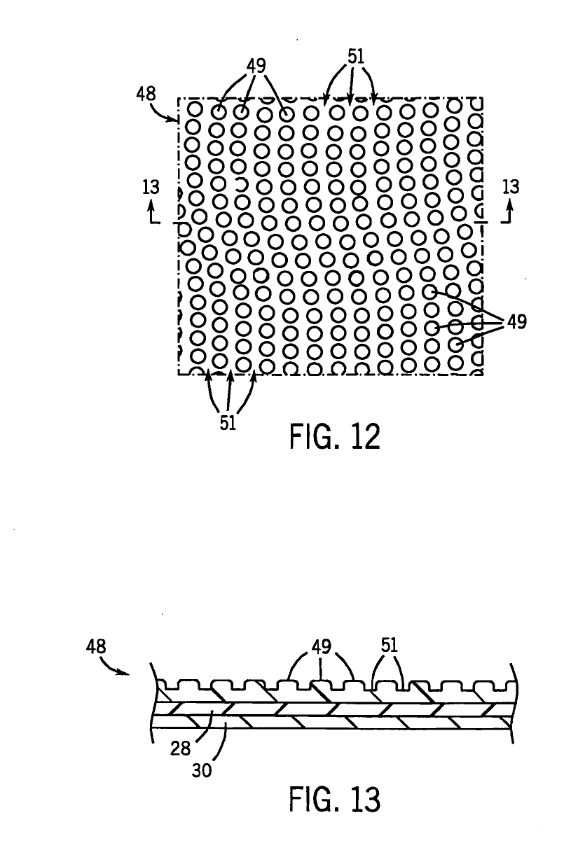

Turning now to FIGS. 6 and 7, there is shown an alternative embodiment of the sill gasket identified by the reference numeral 46. This sill gasket design is used chiefly to prevent water and insect infiltration in window installation. In this version, the foam 14 has its rear edge 22 modified with an upstanding finger 23, and its upper surface 16 sloped downwardly towards the front edge 20 for a reason to be explained below. In addition, the release liner 34 on the top face of the flange 32 is replaced by a drain member 48. As seen in FIGS. 12 and 13, the drain member 48 is preferably a thin sheet made of a water resistant, flexible plastic or other material having a plurality of raised dimples 49 which form a series of flow paths so that water will flow freely along the drain member 48. It should be understood, however, that the drain member 48 contemplates other designs which promote free flow of water from the sloped surface 16 of foam 14.

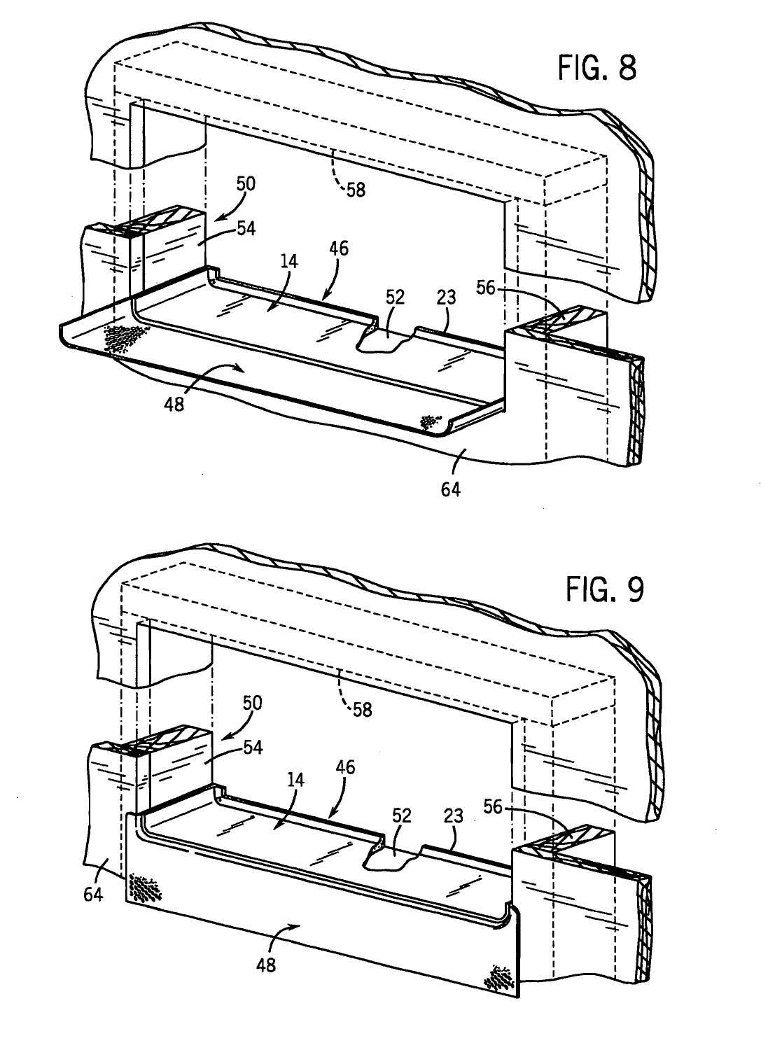

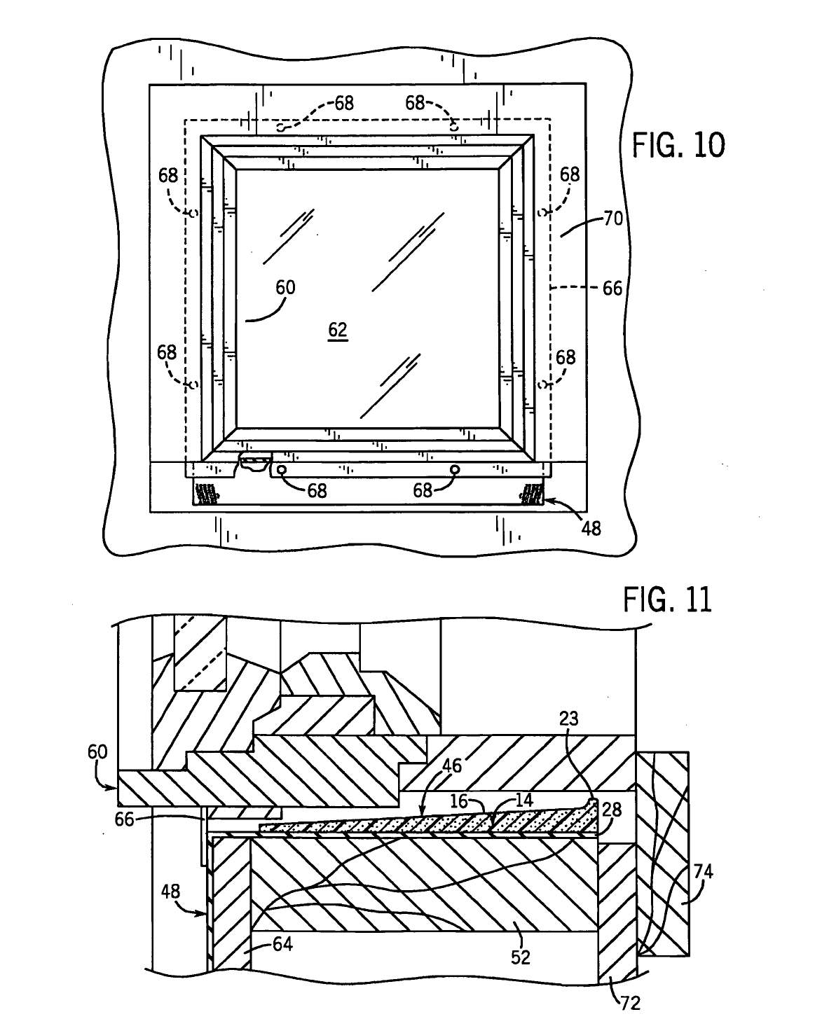

Referring now to FIGS. 8 and 9, a framework 50 includes a bottom member or window sill 52 extending across the lower ends of a pair of spaced side members 54, 56, and a top member 58 connected transversely to the upper ends of the side members 54,56. The four sided framework 50 defines an opening or a window frame 60 having a window 62 as seen in FIGS. 10 and 11. A sheathing material 64 is applied across the front of the framework 50.

To position the sill gasket 46 at the bottom of the framework 50, as seen in FIG. 8, the installer removes the paper release liner 30 from the lower face of the membrane 28, and adhesively secures the membrane 28 with the foam 14 attached along inner surfaces of the entire length of the window sill 52 and short lengths of the side members 54, 56. During installation, a short length of the flange 32 with drain member 48 is attached to the front edge of bottom member 52 and side members 54, 56, and the remainder of the flange 32 projects forwardly from the sill or bottom member 52, as best seen in FIG. 11. Next, the installer folds the flange 32 downwardly and adhesively applies the flange 32 to the front surface or sheathing material 64 adjacent sill 52 as seen in FIG. 10. The sill gasket 46 is fully installed at this point such that the upper surface 16 of the foam 14 slopes towards the front of the framework 50 so as to direct any water which leaks from the window along flow paths of the drain member 48 and positively out of the window opening. Next, the window frame 60 is positioned in the window opening of the framework 50 so that a peripheral window frame flange 66 overlaps marginal portions of the top member 58, side members 54, 56, and the sheathing material 64 as illustrated in FIG. 10. The bottom of window frame 60 is conveniently supported on the drain member 48. The window frame 60 is held in place by inserting mechanical fasteners 68 through the window flange 66 into the framework 50. Finally, it is suggested that a sealing tape 70 having a removable release liner is applied to overlap the window flange 66 and the sheathing material 64 along the front surfaces of the top member 58 and side members 54, 56.

With this construction, any moisture that leaks into the window through window flange 66 or the window itself can be channeled with positive flow forwardly and outwardly by the particular downward slope of the foam 14 and be quickly directed down and away from the window by the flow paths 51 of drain member 48. Such moisture is prevented from escaping rearwardly by the finger 23 at the rear of foam 14 which acts as a backdam. Any moisture intrusion from rain or snow is prevented from entering the window by the gasket 46 and the sealing tape 70.

FIG. 11 depicts the window installation of the sill gasket 46 in cross section and shows the rear of the window sill 52 provided with drywall 72. Window trim 74 may be placed between the rear of the window frame 60 and the drywall 72. Also, a layer of Tyvek protective house wrap (not shown) may be optionally placed over the sheathing material 64 before the sill gasket 46 is applied.

When installing door sill gasket 10 or window sill gasket 46, it should be appreciated that the tremendous elasticity of the membrane 28 enables an installer to easily pull and position the flange 32 onto the sheathing material 42 or 64 as desired. The membrane 28 has a particular construction which is air and moisture impermeable and helps define a long lasting, effective sealing gasket which is 100 percent waterproof, and is mold and mildew resistant. As a result, subfloors and sills are prevented from rotting, swelling and warping, finish flooring is not destroyed, and energy losses are abated with a noticeable savings in energy costs. In the case of the window sill gasket 46, the compressible material or foam 14 adds to the versatility of enabling more or denser insulation to be “chinked in” around the window than can be done with a hard substrate. The sealing gasket 10 or 46 features a simple peel and stick application which contributes to a further savings in labor costs, and is adherent to a variety of materials including wood, concrete and metal.

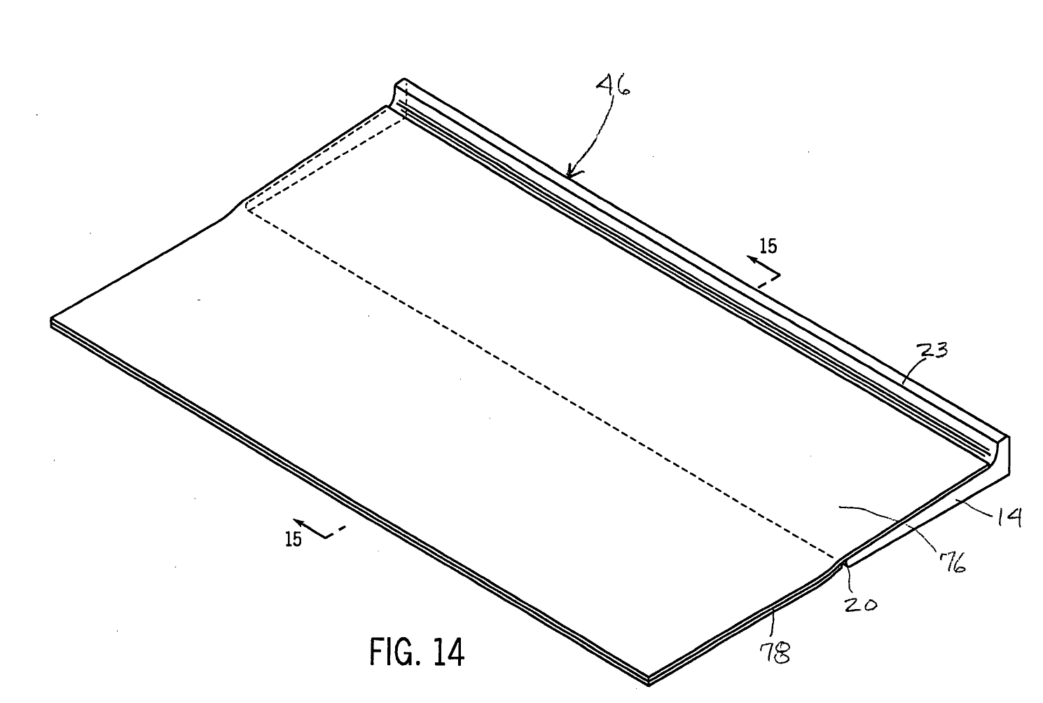

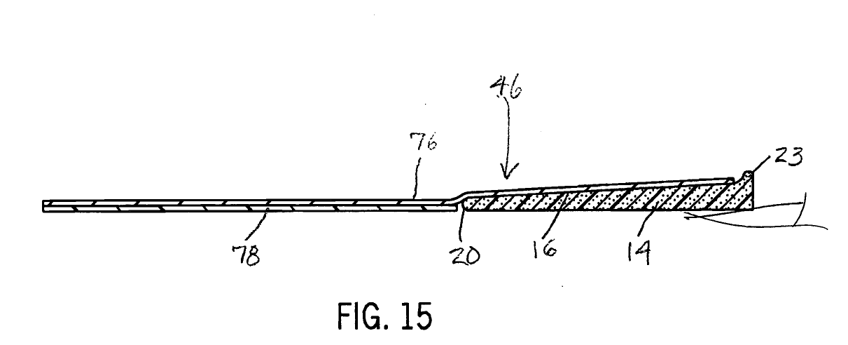

FIGS. 14-16 illustrate a further alternative embodiment in which the downwardly sloping upper surface 1.6 of sill gasket 46 is provided with a peel-and-stick, waterproofed, flexible, wicking material 76 that evacuates any moisture in the window opening to an exterior weather plane of the window. In particular, the wicking material 76 extends from the finger or backdam 23 outwardly beyond the front edge 20 of the foam 14. FIGS. 14 and 15 show one portion of the wicking material 76 attached, such as by adhesive, along substantially the entire upper surface 16. The remaining portion of the wicking material 76 extending beyond front edge 20 is initially provided with a release liner 78 that covers an adhesive under surface of the wicking material 76.

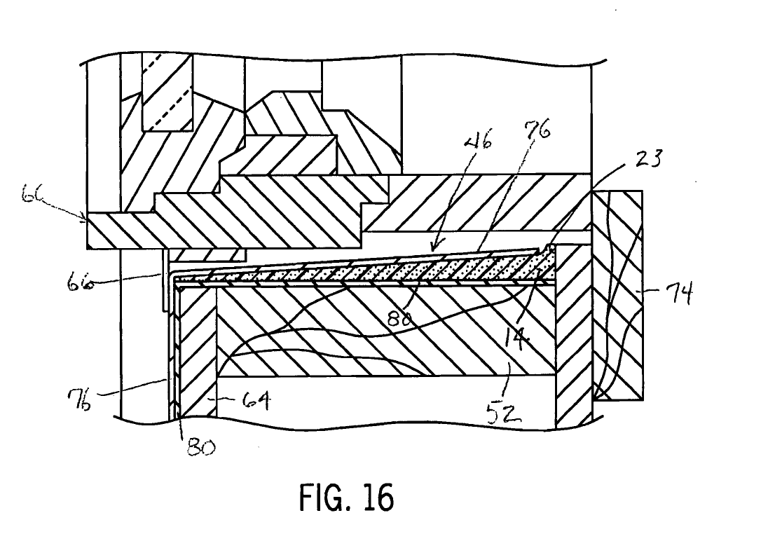

FIG. 16 shows a finished installation of the sill gasket 46 having wicking material 76 with the window installed. Here the bottom surface of sill gasket 46 is first attached, such as by adhesive, to a horizontal portion of protective wrap or flashing 80 running along the sill 52 and the front surface or sheathing material 64. Release liner 78 is removed and the wicking material 76 is folded downwardly and adhesively applied to the flashing 80 over the sheathing material 64. Once the combined gasket 46 and wicking material 76 are installed, the window frame 60 is installed, as described above, such that flange 66 overlaps the wicking material 76.

The wicking material is a commercial grade material designed to absorb and wick any moisture condensation or water inside the window opening to the outside of the window so as to prevent mold, rot and related structural damage. This wicking type gasket 46 is useful with aluminum, vinyl and wood windows, and virtually eliminates all problems caused by window leaks. The sealing gasket 46 and wicking material 76 may also be used on a door sill.

While the invention has been described with reference to a preferred embodiment, those skilled in the art will appreciate that certain substitutions, alterations and omissions may be made without departing from the spirit thereof. Accordingly, the foregoing description is meant to be exemplary only and should not be deemed limitative on the scope of the invention set forth with the following claims.

1. A sill gasket adapted to seal the frame of a structure against moisture and/or air, the gasket comprising:
a water resistant compressible material having an upper surface, a lower surface, a front edge and a rear edge provided with an upstanding backdam, the upper surface being downwardly sloped from the backdam towards the front edge; and
a flexible wicking material having one portion fixed to the upper surface of the compressible material, and another portion extending beyond the front edge and provided with an adhesively coated lower face covered by a removable release liner.

2.-5. (canceled)
